(19) United States
(12) Patent Application Publication
(10) Pub. No.: US 2026/0227591 A1
(43) Pub. Date: Aug. 6, 2026

(54) FAN-IN/FAN-OUT DEVICE AND OPTICAL COMMUNICATION APPARATUS

(71) Applicant: Fujikura Ltd., Tokyo (JP)

(72) Inventor: Takuya Oda, Sakura-shi, Chiba (JP)

(73) Assignee: Fujikura Ltd., Tokyo (JP)

(21) Appl. No.: 19/152,269

(22) PCT Filed: Feb. 15, 2024
(86) PCT No.: PCT/JP2024/005384

§ 371 Date: Jul. 30, 2025

(30) Foreign Application Priority Data
Feb. 17, 2023 (JP) 2023-023216

(51) Int. Cl. G02B 6/44

(52) U.S. Cl. CPC G02B 6/44715

(57) ABSTRACT

A fan-in/fan-out device includes single-core fibers and a waveguide member including waveguides that are each optically coupled to a core of a corresponding one of the single-core fibers, and connect to an optical communication member. A distance between adjacent waveguides of the waveguides on a side of the single-core fibers is equal to or greater than a distance between adjacent waveguides of the waveguides on a side opposite to the single-core fibers. An optical characteristic of a first coupling waveguide including the core of a first single-core fiber of the single-core fibers and the waveguide coupled to the core of the first single-core fiber is different from an optical characteristic of a second coupling waveguide including the core of a second single-core fiber of the single-core fibers and the waveguide coupled to the core of the second single-core fiber.

### BACKGROUND

### Technical Field

The present invention relates to a fan-in/fan-out device and optical communication apparatus.

### Discussion of the Background

In order to achieve an increase in transmission capacity in an optical fiber communication device, it is known to transmit a plurality of signals by light propagating through each core using a multicore fiber in which an outer periphery of plurality of cores as a waveguide is surrounded by one cladding. Patent Literature 1 below describes a fan-in/fan-out device that is a device that performs incidence of light into a multicore fiber and emission of light from the multicore fiber. A fan-in/fan-out device may be referred to as a FIFO.

A FIFO in Patent Literature 1 below includes a plurality of single-core fibers and a pitch conversion unit that has a plurality of waveguides optically coupled to cores of the single-core fibers and converts a pitch between the waveguides.

By coupling each waveguide of the pitch conversion unit to each core of the multicore fiber, light can be incident on the multicore fiber and light can be emitted from the multicore fiber from a plurality of single-core fibers.
Patent Literature 1: JP 2019-152804 A

In such a FIFO, there is a demand for identifying a specific single-core fiber in a case where the FIFO is connected to an optical communication member such as a multicore fiber.

### SUMMARY

One or more embodiments provide a fan-in/fan-out device that can identify a specific single-core fiber when connected to an optical communication member, and an optical communication apparatus.

A first aspect of one or more embodiments is a fan-in/fan-out device including a plurality of single-core fibers, and a waveguide member including a plurality of waveguides each optically coupled to a core of the single-core fibers and connectable to an optical communication member, in which a distance between the plurality of waveguides on a side of the single-core fibers is equal to or more than a distance between the plurality of waveguides on a side opposite to the single-core fibers, and an optical characteristic of a specific coupling waveguide (first coupling waveguide) including the core of a specific single-core fiber (first single-core fiber) out of the plurality of single-core fibers and the waveguide of the waveguide member coupled to the core is different from an optical characteristic of another coupling waveguide (second coupling waveguide) including the core of another single-core fiber (second single-core fiber) of the single-core fibers and another waveguide of the waveguides of the waveguide member coupled to the core.

According to the first aspect, in the case of being connected to the optical communication member, the specific single-core fiber can be identified by examining optical characteristics. Examples of a method for examining optical characteristics include measurement by an optical time domain reflectometer (OTDR), an optical frequency domain reflectometry (OFDR), an optical loss test set (OLTS), and the like. In particular, in a case where the OTDR and the OFDR are used, the optical characteristics can be examined only by causing light to enter from one side in an optical communication apparatus in which the fan-in/fan-out device is connected to the optical communication member, and thus measurement can be easily implemented.

A second aspect of one or more embodiments is the fan-in/fan-out device according to the first aspect, in which a propagation loss of light of the specific coupling waveguide is different from a propagation loss of light of the another coupling waveguide.

According to the second aspect, for example, a specific single-core fiber can be easily identified by an OTDR.

A third aspect of one or more embodiments is the fan-in/fan-out device according to the first or second aspect, in which a propagation loss of light of a wavelength other than a communication wavelength band is different between the specific coupling waveguide and the another coupling waveguide.

In optical communication, it is preferable that a variation in propagation loss of light propagating through each coupling waveguide is small. According to the third aspect, by using light of a wavelength other than the communication wavelength band in order to examine the specific coupling waveguide, the specific single-core fiber can be identified even when the variation in propagation loss of the light of a wavelength of the communication wavelength band in the coupling waveguides is small.

A fourth aspect of one or more embodiments is the fan-in/fan-out device according to any one of the first to third aspects, in which a curvature of the specific single-core fiber is different from a curvature of the another of the single-core fibers.

According to the fourth aspect, a bending loss of light in a core of the specific single-core fiber and a bending loss of light in a core of the another single-core fiber can be made different, and an optical characteristic of a specific coupling waveguide and an optical characteristic of another coupling waveguide can be easily made different.

A fifth aspect of one or more embodiments is the fan-in/fan-out device according to any one of the first to fourth aspects, in which a loss of light at a connection portion (first connection portion) where the specific single-core fiber and the waveguide member are connected in the specific coupling waveguide is different from a loss of light at a connection portion (second connection portion) where the another single-core fiber and the waveguide member are connected in the another coupling waveguide in the connection portion.

According to the fifth aspect, for example, a specific single-core fiber can be easily identified by an OTDR. Here, in the case of a short single-core fiber, since the propagation loss is small, an error of the measured propagation loss may be large. However, according to the fifth aspect, since the loss of light due to the connection portion is used, even if the single-core fiber is short, an error can be suppressed to identify a specific single-core fiber.

A sixth aspect of one or more embodiments is the fan-in/fan-out device according to the fifth aspect, in which an amount of eccentricity between the core and the waveguide at the connection portion in the specific coupling waveguide is different from an amount of eccentricity between the core and the waveguide at the connection portion in the another coupling waveguide.

When the waveguide member includes a multicore fiber and a pitch conversion unit that optically couples the core of each of the single-core fibers and each of the cores of the multicore fiber, the connection state between the core of each of the single-core fibers and the pitch conversion unit can be individually adjusted. However, when the position of the multicore fiber with respect to the pitch conversion unit is shifted, the positions of all the cores of the multicore fibers with respect to the pitch conversion units are shifted, and thus it is difficult to individually adjust the connection state between each of the cores of the multicore fiber and the pitch conversion unit. Thus, when such a pitch conversion unit is used in the sixth aspect, the optical characteristics of the specific coupling waveguide and the optical characteristics of the other coupling waveguide can be easily made different from each other as compared with the case where the loss of light at the connection portion between the multicore fiber and the pitch conversion unit in the specific coupling waveguide and the loss of light at the connection portion between the multicore fiber and the pitch conversion unit in the other coupling waveguide are made different from each other.

A seventh aspect of one or more embodiments is the fan-in/fan-out device according to any one of the first to sixth aspects, in which an effective refractive index in the specific coupling waveguide is different from an effective refractive index in the another coupling waveguide.

According to the seventh aspect, even if the single-core fiber is short, an error can be suppressed to identify a specific single-core fiber.

An eighth aspect of one or more embodiments is the fan-in/fan-out device according to any one of the first to seventh aspects, in which the specific single-core fiber is formed by connecting end portions of a plurality of optical fiber portions to each other, and a loss of light at a connection portion between the optical fiber portions in the specific coupling waveguide is different from a loss of light at a position corresponding to the connection portion of the specific coupling waveguide in the other coupling waveguide.

According to the eighth aspect, even if the single-core fiber is short, an error can be suppressed to identify a specific single-core fiber. As such an example, there can be exemplified a form in which a specific single-core fiber is formed by connecting ends of a plurality of optical fiber portions to each other, and another single-core fiber is formed by one optical fiber portion.

A ninth aspect of one or more embodiments is the fan-in/fan-out device according to any one of the first to eighth aspects, in which the specific single-core fiber and the another single-core fiber are formed by connecting end portions of a plurality of optical fiber portions to each other, and a number of connection portions between the optical fiber portions in the specific single-core fiber is different from a number of connection portions between the optical fiber portions in the another single-core fiber.

According to the ninth aspect, for example, a specific single-core fiber can be identified by measuring the number of connection portions by an OTDR or the like. In this case, a specific single-core fiber is identified on the basis of a discrete natural number such as the number of connection portions, but a loss such as a propagation loss generally does not become a natural number. Thus, it is possible to easily identify a specific single-core fiber as compared with the case of identifying a specific single-core fiber based on difference in loss such as a propagation loss.

A tenth aspect of one or more embodiments is the fan-in/fan-out device according to any one of the first to ninth aspects, in which the specific single-core fiber is provided with an optical element that reflects light of a specific wavelength, and a reflectance of the light of the specific wavelength at a position where the optical element is provided in the specific coupling waveguide is different from a reflectance of the light of the specific wavelength at a position corresponding to a position where the optical element is provided in the specific coupling waveguide in the another coupling waveguide.

According to the tenth aspect, by setting the specific wavelength to a wavelength other than the communication wavelength band, it is possible to identify a specific single-core fiber while suppressing the influence on the transmission quality.

An eleventh aspect of one or more embodiments is the fan-in/fan-out device according to any one of the first to tenth aspects, in which a length of the specific single-core fiber is different from lengths of the another single-core fiber.

According to the eleventh aspect, it is possible to easily make an optical characteristic of a specific coupling waveguide different from an optical characteristic of another coupling waveguide.

A twelfth aspect of one or more embodiments is the fan-in/fan-out device according to any one of first to eleventh aspects, in which the waveguide member includes a multicore fiber and a pitch conversion unit that optically couples the core of each of the single-core fibers and each of cores of the multicore fibers, and the multicore fiber has a marker in which a distance from the core of the multicore fiber that is a part of the specific coupling waveguide is smaller than a distance from the core of the multicore fiber that is a part of the another coupling waveguide.

As light propagates through the core, some of the light seeps out of the core. As noted above, in the twelfth aspect, the marker is closest to a core of a multicore fiber that becomes part of a particular coupling waveguide. Thus, the light leaking from the core of the multicore fiber to be a part of the specific coupling waveguide is easily affected by the marker, and the loss of light propagating through the core can be made larger than the loss of light propagating through the other cores. Therefore, according to the twelfth aspect, for example, even if the materials constituting the cores of the multicore fibers are the same, the optical characteristic of a specific coupling waveguide can be made different from the optical characteristics of other coupling waveguides.

A thirteenth aspect of one or more embodiments is an optical communication apparatus including a pair of fan-in/fan-out devices including a plurality of single-core fibers and a waveguide member including a plurality of waveguides each optically coupled to a core of the single-core fibers, in which a distance between the plurality of waveguides on a side of the single-core fibers is equal to or more than a distance between the plurality of waveguides on a side opposite to the single-core fibers, and a transmission multicore fiber optically coupling each of the waveguides of the waveguide member of one of the fan-in/fan-out devices and each of the waveguides of the waveguide member of another of the fan-in/fan-out devices, in which at least one of the fan-in/fan-out devices is the fan in/fan-out device of any one of aspects 1 to 12.

According to the thirteenth aspect, for example, light for examining a particular coupling waveguide in one fan-in/fan-out device may be caused to enter from a single-core fiber in the other fan-in/fan-out device to identify a single-core fiber in the other fan-in/fan-out device that couples to a particular single-core fiber in the one fan-in/fan-out device.

As described above, according to one or more embodiments, a fan-in/fan-out device and an optical communication apparatus capable of identifying a specific single-core fiber when connected to an optical communication member are provided.

### BRIEF DESCRIPTION OF THE DRAWINGS

FIG. 1 is a conceptual diagram illustrating an optical communication apparatus according to a first example of one or more embodiments.

FIG. 2 is a view illustrating a cross section perpendicular to a longitudinal direction of a transmission multicore fiber illustrated in FIG. 1.

FIG. 3 is a view illustrating a cross section perpendicular to a longitudinal direction of a single-core fiber.

FIG. 4 is an exploded perspective view illustrating one fan-in/fan-out device.

FIG. 5 is a diagram illustrating optical characteristics of the optical communication apparatus according to the first example.

FIG. 6 is a diagram illustrating, as in FIG. 5, optical characteristics of an optical communication apparatus according to a second example.

FIG. 7 is a conceptual diagram illustrating an optical communication apparatus according to a third modification.

FIG. 8 is a conceptual diagram illustrating an optical communication apparatus according to a fourth modification.

FIG. 9 is a conceptual diagram illustrating an optical communication apparatus according to a sixth modification.

FIG. 10 is a view illustrating a cross section perpendicular to a longitudinal direction of a multicore fiber according to a seventh modification.

### DESCRIPTION OF THE EMBODIMENTS

Hereinafter, a fan-in/fan-out device and an optical communication apparatus according to one or more embodiments will be described in detail with reference to the drawings. The embodiments exemplified below are intended to facilitate understanding of the present invention and are not intended to limit the present invention. The present invention can be modified and improved from the embodiments in the scope of the claims. Note that, for easy understanding, scales in the respective drawings may be different from scales described in the following description.

### First Example

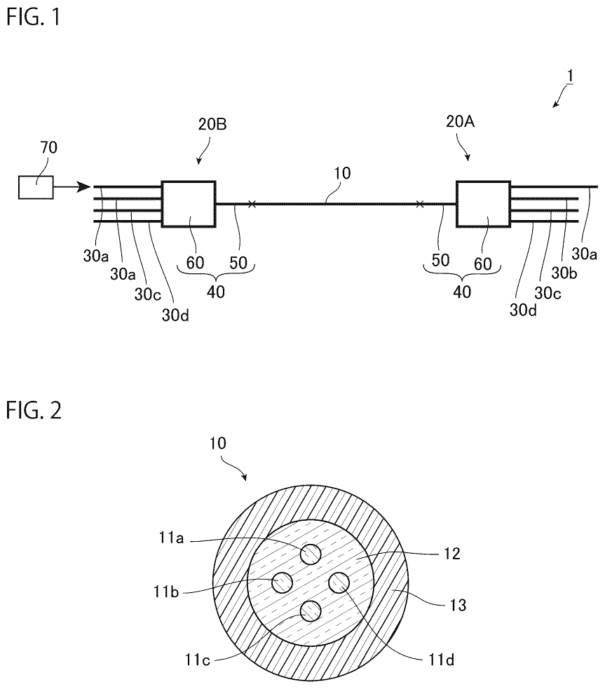

FIG. 1 is a conceptual diagram illustrating an optical communication apparatus according to a first example of one or more embodiments. The optical communication apparatus 1 according to the present example mainly includes a transmission multicore fiber 10 and a pair of fan-in/fan-out devices 20A and 20B.

FIG. 2 is a view illustrating a cross section perpendicular to a longitudinal direction of a transmission multicore fiber 10 illustrated in FIG. 1. The transmission multicore fiber 10 according to the present example is a non-coupled multicore fiber, and includes four cores 11a to 11d, a cladding 12 that surrounds outer peripheral surfaces of the cores 11a to 11d with no gap, and a coating layer 13 that coats an outer peripheral surface of the cladding 12. Note that the number of cores may be plural and is not limited.

In the present example, the outer shape in the cross section perpendicular to the longitudinal direction of the cladding 12 is substantially circular, and the cores 11a to 11d are disposed at positions that are substantially four times rotationally symmetric about the center of the cladding 12.

The refractive index of each of the cores 11a to 11d is higher than the refractive index of the cladding 12, and in the present example, relative refractive index differences of the cores 11a to 11d with respect to the cladding 12 are the same. Such cores 11a to 11d are made of, for example, silica glass to which a dopant such as germanium having a high refractive index is added, and the cladding 12 is made of, for example, silica glass to which no dopant is added. In addition, the cores 11a to 11d may be made of silica glass to which no dopant is added, and the cladding 12 may be made of silica glass to which a dopant such as fluorine having a low refractive index is added.

The coating layer 13 is made of a resin such as an ultraviolet curable resin.

Next, the fan-in/fan-out devices 20A and 20B will be described. Note that, hereinafter, the fan-in/fan-out devices 20A and 20B may be referred to as FIFOs 20A and 20B, respectively.

In the present example, since configurations of the pair of FIFOs 20A and 20B are substantially the same, one FIFO 20A will be described below, and the other FIFO 20B will be denoted by the same reference numeral unless otherwise specified and redundant description will be omitted.

As illustrated in FIG. 1, the FIFO 20A the present example mainly includes four single-core fibers 30a to 30d and a waveguide member 40 connectable to a transmission multicore fiber 10 as an optical communication member. Note that the number of single-core fibers 30a to 30d only needs to be the same as the number of cores 11a to 11d of the transmission multicore fiber 10, and changes according to the number of cores 1la to 11d. Further, although described in detail later, the waveguide member 40 has four waveguides optically coupled to the core 31 of each of the single-core fibers 30a to 30d. Thus, the FIFO 20A has four waveguides.

In the present example, configurations of the single-core fibers 30a to 30d are the same except for the length. Thus, hereinafter, the single-core fiber 30a will be described, and the other single-core fibers 30b to 30d are denoted by the same reference numerals and redundant description is omitted unless otherwise specified.

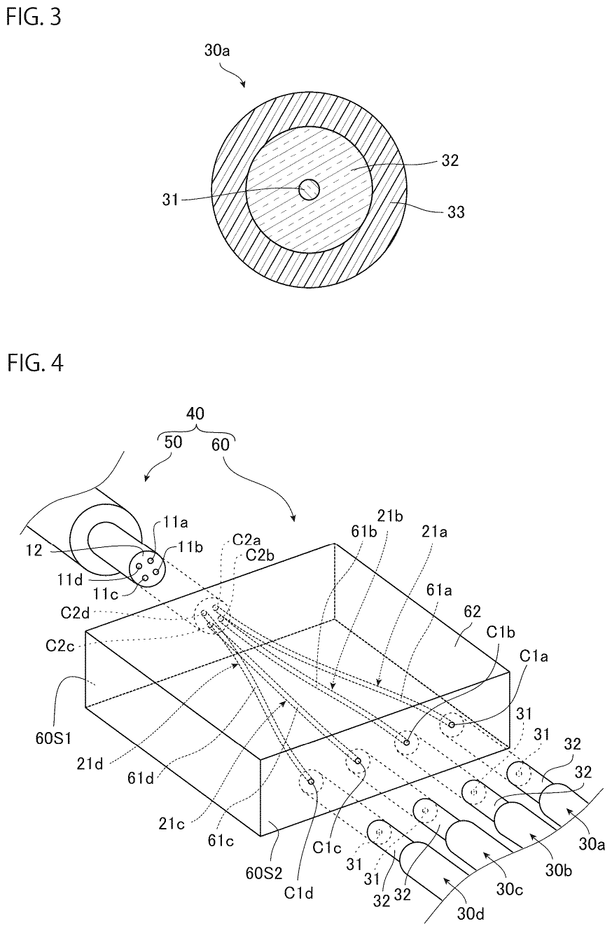

FIG. 3 is a view illustrating a cross section perpendicular to a longitudinal direction of the single-core fiber 30a. The single-core fiber 30a according to the present example includes a core 31, a cladding 32 surrounding an outer peripheral surface of the core 31 with no gap, and a coating layer 33 coating an outer peripheral surface of the cladding 32. The single-core fiber 30a may be a single-mode fiber or a multi-mode fiber.

In the present example, the outer shape in the cross section perpendicular to the longitudinal direction of the cladding 32 is substantially circular, and the core 31 is disposed at the center of the cladding 32. The diameter of the core 31 is substantially the same as diameters of the cores 11a to 11d of the transmission multicore fiber 10.

The refractive index of the core 31 is higher than the refractive index of the cladding 32. Such a core 31 is made of, for example, silica glass to which a dopant having a high refractive index is added, and the cladding 32 is made of, for example, silica glass to which no dopant is added. In addition, the core 31 may be made of silica glass to which no dopant is added, and the cladding 32 may be made of silica glass to which a dopant having a low refractive index is added.

The coating layer 33 is made of a resin such as an ultraviolet curable resin.

As illustrated in FIG. 1, in the FIFO 20A of the present example, the length of the single-core fiber 30a is different from the lengths of the other single-core fibers 30b to 30d. Specifically, the single-core fiber 30a is longer than the other single-core fibers 30b to 30d, and the lengths of the other single-core fibers 30b to 30d are the same. A difference between the length of the single-core fiber 30a and the lengths of the single-core fibers 30b to 30d is, for example, 10% or more and less than 30% of the length of the single-core fibers 30b to 30d, and is 100 mm or more and 4000 mm or less. On the other hand, the lengths of the single-core fibers 30a to 30d in the FIFO 20B are the same.

FIG. 4 is an exploded perspective view illustrating the FIFO 20A, and in FIG. 4, one end sides of the single-core fibers 30a to 30d are illustrated and description of the other end side is omitted. The waveguide member 40 of the present example includes a multicore fiber 50 and a pitch conversion unit 60. The multicore fiber 50 according to the present example has the same configuration as the transmission multicore fiber 10, and includes four cores 11a to 11d, a cladding 12, and a coating layer 13. In FIG. 4, one end side in the longitudinal direction of the multicore fiber 50 is illustrated, and illustration of the other end side is omitted. At an end portion on one end side of the multicore fiber 50, the coating layer 13 is removed, and the cladding 12 is exposed.

The pitch conversion unit 60 of the present example includes a waveguide substrate having a substantially rectangular parallelepiped shape and is made of a light transmissive material. The pitch conversion unit 60 includes four waveguides 61a to 61d extending between end surfaces 60S1 and 60S2 facing each other, and a cladding 62 is formed around the waveguides 61a to 61d. The refractive indexes of the waveguides 61a to 61d are higher than the refractive index of the cladding 62, and in the present example, relative refractive index differences of the waveguides 61a to 61d with respect to the cladding 62 are the same.

The arrangement of the waveguides 61a to 61d on the end surface 60S1 corresponds to the arrangement of the cores 11a to 11d in the multicore fiber 50, and the diameters of the waveguides 61a to 61d on the end surface 60S1 are substantially the same as the diameters of the cores 11a to 11d in the multicore fiber 50. The waveguides 61a to 61d are linearly arranged in a line on the end surface 60S2. The distance between the waveguides 61a to 61d at the end surface 60S2 is larger than the distance between the waveguides 61a to 61d at the end surface 60S2. Further, the diameters of the waveguides 61a to 61d are substantially constant in an extending direction. Note that the arrangement of the waveguides 61a to 61d on the end surface 60S2 is not limited, and for example, the waveguides may be arranged at predetermined intervals on a predetermined circumference.

Such waveguides 61a to 61d can be formed, for example, by irradiating a light transmissive base material with a femtosecond laser. Examples of the material of the light transmissive substrate include silica glass and a transparent resin. Note that the pitch conversion unit 60 is not limited to this example, and may be, for example, a planar lightwave circuit (PLC) that forms the waveguides 61a to 61d by adding an element to a substrate made of silica glass, silicon photonics in which the waveguides 61a to 61d are made of silicon, a polymer waveguide, or the like.

The multicore fiber 50 is aligned so that one end of the core 11a faces one end of the waveguide 61a, one end of the core 11b faces one end of the waveguide 61b, one end of the core 11c faces one end of the waveguide 61c, and one end of the core 11d faces one end of the waveguide 61c. One end of the multicore fiber 50 is connected to the end surface 60S1 of the pitch conversion unit 60 by an adhesive. Thus, the core 11a and the waveguide 61a are optically coupled, the core 11b and the waveguide 61b are optically coupled, the core 11c and the waveguide 61c are optically coupled, and the core 11d and the waveguide 61d are optically coupled. That is, the waveguide member 40 includes a waveguide including the core 11a and the waveguide 61a, a waveguide including the core 11b and the waveguide 61b, a waveguide including the core 11c and the waveguide 61c, and a waveguide including the core 11a and the waveguide 61a. One ends of these four waveguides are cores 11a to 11d at an end of the multicore fiber 50 opposite to the pitch conversion unit 60 side, and the other ends are waveguides 61a to 61d on the end surface 60S2 of the pitch conversion unit 60. Then, a distance between the waveguides on the other end side is larger than a distance between the waveguides on the one end side.

At an end portion on one end side of each of the single-core fibers 30a to 30d, the coating layer 33 is removed, and the cladding 32 is exposed. End portions on one end sides of the single-core fibers 30a to 30d are connected to the end surface 60S2 of the pitch conversion unit 60 with an adhesive so that the cores 31 and the waveguides 61a to 61d of the pitch conversion unit 60 are individually and optically coupled. Thus, in the FIFO 20A, a coupling waveguide 21a including the core 31, the waveguide 61a, and the core 11a of the single-core fiber 30a, a coupling waveguide 21b including the core 31, the waveguide 61b, and the core 11b of the single-core fiber 30b, a coupling waveguide 21c including the core 31, the waveguide 61c, and the core 11c of the single-core fiber 30c, and a coupling waveguide 21d including the core 31, the waveguide 61d, and the core 11d of the single-core fiber 30d are formed.

The other end of the multicore fiber 50 of the FIFO 20A is connected to one end of the transmission multicore fiber 50 with an adhesive so that the cores 11a to 11d of the multicore fiber 10 and the cores 11a to 11d of the transmission multicore fiber 10 are individually optically coupled. Further, the other end of the multicore fiber 50 of the FIFO 20B is connected to the other end of the transmission multicore fiber 10 by an adhesive so that the cores 11a to 11d of the multicore fiber 50 and the cores 11ato 11d of the transmission multicore fiber 10 are individually and optically coupled. That is, the transmission multicore fiber 10 optically couples the four waveguides of the waveguide member 40 of the FIFO 20A and the four waveguides of the waveguide member 40 of the FIFO 20B. Then, in the optical communication apparatus 1, four waveguides in which the cores 31 of the single-core fibers 30a to 30d of the FIFO 20A and the cores 31 of the single-core fibers 30a to 30d of the FIFO 20B are optically coupled via the transmission multicore fibers 10 are formed. As described above, in the FIFO 20A, the single-core fiber 30a is longer than the other single-core fibers 30b to 30d. Thus, among the four waveguides in the optical communication apparatus 1, the waveguide including the core 31 of the single-core fiber 30a of the FIFO 20A is longer than the other waveguides.

The method of connection between the multicore fiber 50 and the pitch conversion unit 60, connection between the single-core fibers 30a to 30d and the pitch conversion unit 60, and connection between the multicore fiber 50 and the multicore fiber 50 of the FIFO 20B is not limited to connection using an adhesive. The method of connecting these members may be, for example, connection by fusion, connection using a connector, mechanical splice connection, or the like.

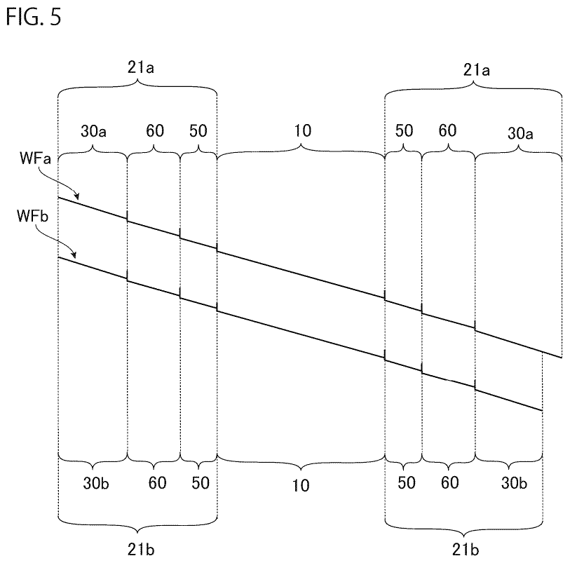

FIG. 5 is a diagram illustrating optical characteristics of the optical communication apparatus 1 according to the present example, and is a diagram illustrating waveforms measured by an OTDR 70 illustrated in FIG. 1. The incident position of the measurement light of the OTDR 70 is an end opposite to the waveguide member 40 side of each of the single-core fibers 30a to 30d in the FIFO 20B. In addition, the measurement light is light of a wavelength other than the communication wavelength band, but may be light of the communication wavelength band. In FIG. 5, a waveform WFa when the measurement light is incident on the single-core fiber 30a and a waveform WFb when the measurement light is incident on the single-core fiber 30b are arranged in a vertical direction. In addition, FIG. 5 also illustrates reference numerals of configurations of the corresponding optical communication apparatuses 1 in the waveforms WFa and WFb. As illustrated in FIG. 5, a portion of the waveform WFa corresponding to the single-core fiber 30a of the FIFO 20A is longer than a portion of the waveform WFb corresponding to the single-core fiber 30b of the FIFO 20A. Note that, although not illustrated, a waveform when the measurement light is incident on the single-core fiber 30c and a waveform when the measurement light is incident on the single-core fiber 30d are substantially the same as the waveform WFb. Thus, optical characteristic of the coupling waveguide 21a in the FIFO 20A is different from those of the other coupling waveguides 21b to 21d. On the other hand, the optical characteristics of the coupling waveguides 21a to 21d in the FIFO 20B are substantially the same.

As described above, the optical communication apparatus 1 according to the present example includes the pair of FIFOs 20A and 20B and the transmission multicore fiber 10. The FIFOs 20A and 20B include single-core fibers 30a to 30d and the waveguide member 40 connectable to a transmission multicore fiber 10 as an optical communication member. In the FIFO 20A, the optical characteristic of the coupling waveguide 21a including the core 31 of the single-core fiber 30a and the waveguide of the waveguide member 40 coupled to the core 31 is different from the optical characteristics of the other coupling waveguides 21b to 21d including the cores 31 of the other single-core fibers 30b to 30d and the other waveguides of the waveguide member 40 coupled to the cores 31. Thus, according to the optical communication apparatus 1 of the present example, as described above, by causing the light for examining the coupling waveguide 21a in one FIFO 20A to enter from the single-core fibers 30a to 30d in the other FIFO 20B, it is possible to identify the single-core fiber in the other FIFO 20A coupled to the single-core fiber 30a in the one FIFO 20A.

In the FIFO 20A of the present example, as described above, the optical characteristic of the coupling waveguide 21a is different from the optical characteristics of the other coupling waveguides 21b to 21d. Therefore, with the FIFO 20A of the present example, in a case of being connected to the transmission multicore fiber 10 as an optical communication member, the single-core fiber 30a can be identified by examining optical characteristics. Note that, in the identification of the single-core fiber 30a, the incident position of the measurement light of the OTDR 70 may be an end opposite to the waveguide member 40 side in the single-core fibers 30a to 30d of the FIFO 20A, and the single-core fiber 30a can be identified by examining optical characteristics even in the single FIFO 20A.

In the FIFO 20A of the present example, the length of the single-core fiber 30a is different from the lengths of the other single-core fibers 30b to 30d. Thus, the optical characteristic of the coupling waveguide 21a can be easily made different from the optical characteristics of the other coupling waveguides 21b to 21d. In addition, according to the FIFO of the present example, the single-core fiber 30a can be visually identified. Note that, in the FIFO 20A, the optical characteristic of the coupling waveguide 21a only needs to be different from the optical characteristics of the other coupling waveguides 21b to 21d, and for example, the single-core fiber 30a may be shorter than the other single-core fibers 30b to 30d, and the lengths of the single-core fibers 30a to 30d may be different from each other. In this case, the optical characteristics of the coupling waveguides 21a to 21d are different from each other.

Note that the method of 41 examining the optical characteristics is not limited to measurement by the OTDR 70, and may be measurement by, for example, OFDR, OLTS, or the like. Note that, in a case where the OTDR or the OFDR is used, optical characteristics can be examined only by allowing light to enter from one side in the optical communication apparatus 1 in which the fan-in/fan-out device 20A is connected to the transmission multicore fiber 10 as an optical communication member, and thus measurement can be easily implemented. In addition, since an operator is not required on the other side of the optical communication apparatus 1, the cost can be reduced.

### Second Example

Next, a second example of one or more embodiments will be described in detail. Note that the same or equivalent components as those in the first example are denoted by the same reference numerals, and redundant description is omitted unless otherwise specified.

In an optical communication apparatus 1 of the present example, a FIFO 20A is different from the FIFO 20A of the first example. Specifically, the length of a single-core fiber 30a in the FIFO 20A is the same as the lengths of the other single-core fibers 30b to 30d. Further, the content of the hydroxyl group of the core 31 of the single-core fiber 30a is larger than the content of the hydroxyl group of the core 31 of the single-core fibers 30b to 30d.

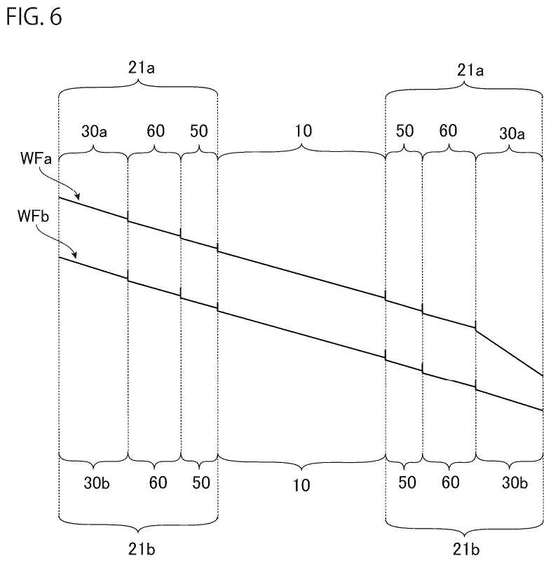

FIG. 6 is a diagram illustrating, as in FIG. 5, optical characteristics of the optical communication apparatus 1 of the present example. Measurement light of the OTDR 70 in the present example is light of 1360 nm or more and less than 1460 nm which is a so-called E band. As illustrated in FIG. 6, in the present example, an inclination of the portion of the waveform WFa corresponding to the single-core fiber 30a of the FIFO 20A is larger than an inclination of the portion of the waveform WFb corresponding to the single-core fiber 30b of the FIFO 20A. That is, the propagation loss of light of the core 31 of the single-core fiber 30a is larger than the propagation loss of light of the cores 31 of the single-core fibers 30b to 30d. In a case where the wavelength of light propagating through the core is 1360 nm or more and less than 1460 nm, which is a so-called E-band, it is known that the loss of light due to the hydroxyl group contained in the core increases, and it may be referred to as OH loss. In the present example, due to the OH loss, the propagation loss of light of the core 31 of the single-core fiber 30a is larger than the propagation losses of light of the cores 31 of the single-core fibers 30b to 30d. Thus, according to the optical communication apparatus 1 of the present example, the single-core fiber 30a in the FIFO 20A can be easily identified by the OTDR 70. Further, the wavelength of light used in optical communication may be in the E-band, and there are existing OTDR, OFDR, OLTS, and the like using light in the wavelength band. Thus, according to the present example, for example, the propagation loss can be measured even in the existing OTDR, OFDR, OLTS, and the like. Therefore, the single-core fiber 30a can be easily identified.

Note that, in the FIFO 20A, the propagation loss of light of the coupling waveguide 21a only needs to be different from propagation losses of light of the other coupling waveguides 21b to 21d. For example, the content of the hydroxyl group of the core 31 of the single-core fiber 30a may be smaller than the contents of the hydroxyl groups of the cores 31 of the single-core fibers 30b to 30d, and the contents of the hydroxyl groups of the cores 31 of the single-core fibers 30a to 30d may be different from each other.

The wavelength of light having different propagation losses between the coupling waveguide 21a and the other coupling waveguides 21b to 21d is not limited. For example, when the wavelength of light propagating through the core is 400 nm or more and less than 600 nm, the loss of light tends to increase depending on the contents of nickel, chromium, cobalt, iron, and copper in the core. When the wavelength of light propagating through the core is 600 nm or more and less than 800 nm, the loss of light tends to increase depending on the contents of nickel, chromium, cobalt, and iron in the core. When the wavelength of light propagating through the core is 800 nm or more and less than 900 nm, the loss of light tends to increase depending on the content of chromium in the core. When the wavelength of light propagating through the core is 900 nm or more and less than 1000 nm, the loss of light tends to increase depending on the contents of chromium and hydroxyl groups in the core. When the wavelength of light propagating through the core is 1000 nm or more and less than 1260 nm, which is a so-called T band, the loss of light tends to increase depending on the contents of nickel, cobalt, and hydroxyl groups in the core. When the wavelength of light propagating through the core is 1260 nm or more and less than 1360 nm, which is a so-called O band, the loss of light tends to increase depending on the contents of nickel and cobalt in the core. When the wavelength of light propagating through the core is in the E-band, the loss of light tends to increase depending on the contents of nickel, cobalt, and hydroxyl groups in the core. When the wavelength of light propagating through the core is 1460 nm or more and less than 1530 nm which is a so-called S band, when the wavelength is 1530 nm or more and less than 1565 nm which is a so-called C band, when the wavelength is 1565 nm or more and less than 1625 nm which is a so-called L band, and when the wavelength is 1625 nm or more and less than 1675 nm which is a so-called U band, the loss of light tends to increase depending on the contents of nickel and cobalt in the core. When the wavelength of light propagating through the core is 1675 nm or more, the loss of light tends to increase depending on the contents of hydroxyl group, cobalt, and nickel in the core. Thus, for example, by adjusting the content of the substance in the core 31 of the single-core fiber 30a or the core 11a of the multicore fiber 50, wavelength bands of light having different propagation losses can be adjusted.

In addition, the propagation loss of the light of the core 11a of the multicore fiber 50 may be different from the propagation losses of the light of the cores 11b to 11d, and the propagation losses of the light of the cores 11a to 11d may be different from each other. Furthermore, the propagation loss of light of the waveguide 61a of the pitch conversion unit 60 may be different from the propagation losses of light of the waveguides 61b to 61d, and the propagation losses of light of the waveguides 61a to 61d may be different from each other.

The coupling waveguide 21a and the other coupling waveguides 21b to 21d preferably have different propagation losses of measurement light having wavelengths other than the communication wavelength band. In optical communication, it is preferable that a variation in propagation loss of light propagating through each of the coupling waveguides 21a to 21d is small. Thus, with the above configuration, by using measurement light of a wavelength other than the communication wavelength band in order to examine the coupling waveguide 21a, the single-core fiber 30a can be identified even when the variation in the propagation loss of the light of a wavelength of the communication wavelength band in the coupling waveguides 21a to 21d is small. Furthermore, in this case, a difference between a propagation loss of the measurement light having a wavelength other than the communication wavelength band in the coupling waveguide 21a and the propagation losses in the other coupling waveguides 21a to 21d is preferably larger than a difference between the propagation loss of light having a wavelength of the communication wavelength band in the coupling waveguide 21a and the propagation loss in the other coupling waveguides 21a to 21d. Thus, with such a configuration, the single-core fiber 30a can be easily identified. For example, when the communication wavelength band is a so-called T band, O band, S band, C band, L band, or U band, as in the present example, the content of the hydroxyl group of the core 31 of the single-core fiber 30a is made different from the contents of the hydroxyl groups of the cores 31 of the single-core fibers 30b to 30d, and light having a wavelength of E band is used as measurement light.

In addition, the wavelength of the measurement light may be equal to or less than a wavelength at which light in a mode having an order higher by one order than the mode of the light of the wavelength of the communication wavelength band propagating through the core 31 can propagate, and the propagation loss of the measurement light may be different between the coupling waveguide 21a and the other coupling waveguides 21b to 21d. With such a configuration, the measurement light propagating through the core 31 includes light of the same mode as the mode of the light of the wavelength of the communication wavelength band propagating through the core 31 and light of a mode higher than the mode of the light. Light of a higher mode tends to leak out from the core through which the light propagates, and is easily affected by a propagation loss factor located at the outer peripheral portion of the core or outside the core. Examples of the propagation loss factor include an element that easily absorbs the measurement light added to the outer peripheral portion of the core or the periphery of the core in the cladding, unevenness of the boundary between the core and the cladding, and the like. When the light of the higher mode leaked out from the core spreads to these propagation loss factors, the loss of the light of the higher mode increases due to the influence of these propagation loss factors. Thus, with such a configuration, for example, the propagation loss of the light of the mode higher than the mode of the light of the wavelength of the communication wavelength band in the core 31 of the single-core fiber 30a is made larger than the propagation loss in the cores 31 of the other single-core fibers 30b to 30d by these propagation loss factors, so that the propagation loss of the measurement light in the core 31 of the single-core fiber 30a is made larger than the propagation losses of the measurement light in the cores 31 of the other single-core fibers 30b to 30d, whereby the propagation loss of the measurement light in the core 31 of the single-core fiber 30a can be made larger. Therefore, the difference between the propagation loss of the measurement light in the coupling waveguide 21a and the propagation losses in the other coupling waveguides 21b to 21d can be made larger than the difference between the propagation loss of the light having the wavelength of the communication wavelength band in the coupling waveguide 21a and the propagation losses in the other coupling waveguides 21b to 21d.

In addition, a propagation loss of light having a wavelength of 800 nm or more and 950 nm or less or a U-band wavelength may be different between the coupling waveguide 21a and the other coupling waveguides 21b to 21d. The wavelength of light used in multi-mode fiber communication may be 800 nm or more and 950 nm or less or a U-band wavelength, and there are existing OTDR, OLTS, and the like using light in the wavelength band. Thus, with such a configuration, for example, the propagation loss can be measured even in an existing OTDR, OLTS, or the like. Therefore, the single-core fiber 30a can be easily identified.

In addition, the propagation loss of light having a wavelength of 360 nm or more and less than 830 nm may be different between the coupling waveguide 21a and the other coupling waveguides 21b to 21d. Light having a wavelength of 360 nm or more and less than 830 nm is visible light, and the light appears dark as the energy decreases. Thus, with such a configuration, for example, the single-core fiber 30a can be identified by visually checking the brightness of return light when the light having the above-described wavelength is caused to enter the core 31 of each of the single-core fibers 30a to 30d. In addition, since the single-core fiber 30a can be identified without using a device for measuring a propagation loss, the cost can be reduced.

In addition, the difference between the propagation loss of light in the coupling waveguide 21a and the propagation losses of light in the other coupling waveguides 21b to 21d is preferably 0.005 dB/km or more, more preferably 0.01 dB/km or more, still more preferably 0.03 dB/km or more, and yet more preferably 0.05 dB/km or more when the wavelength of light is the wavelength of the communication wavelength band. With such a configuration, a difference between a propagation loss of light of the coupling waveguide 21a and a propagation losses of light of the other coupling waveguides 21b to 21d can be easily distinguished, so that the single-core fiber 30a in the FIFO 20A can be easily identified by the OTDR 70. In addition, when the wavelength of light is the wavelength of the communication wavelength band, the above-described difference in propagation loss is preferably 0.1 dB/km or less, and more preferably 0.06 dB/km or less. With such a configuration, It is possible to suppress variation in communication quality for each coupling waveguide. Furthermore, when the wavelength of light is a wavelength of the measurement light other than the communication wavelength band, the above-described difference in propagation loss is preferably 0.1 dB/km or more, more preferably 0.5 dB/km or more, and still more preferably 1.0 dB/km or more. Since the wavelength of light is a wavelength other than the communication wavelength band, even if the loss of light is large, the communication quality is not affected, and with such a configuration, the single-core fiber 30a can be easily identified. In addition, in general, since the difference between the propagation loss of light of the coupling waveguide 21a and the propagation losses of light of the other coupling waveguides 21b to 21d tends to be less than 0.1 dB/km, the difference in propagation loss of light between the other coupling waveguides 21b to 21d is preferably less than 0.1 dB/km. In a case where the above-described difference between the propagation loss of light of the coupling waveguide 21a and the propagation losses of light of the other coupling waveguides 21b to 21d is 0.1 dB/km or more, even a measurement device (for example, a general-purpose measuring device) having a large minimum measurable value of the propagation loss can measure the difference in the propagation loss, so that the single-core fiber 30a can be easily identified. Here, particularly when the waveguide is short, the propagation loss is small, and thus the error of the measured propagation loss may be large. However, since the above-described difference in propagation loss is 0.1dB/km or more, an error can be suppressed and the single-core fiber 30a can be easily identified even if the coupling waveguides 21a to 21d are short. In order to make the difference between the propagation loss of light of the specific coupling waveguide 21a and the propagation losses of light of the other coupling waveguides 21b to 21d larger than the difference in the propagation loss of the light between the other coupling waveguides 21b to 21d in this manner, for example, the same dopant is added in substantially the same amount to the cores of the single-core fibers 30b to 30d of the other coupling waveguides 21b to 21d, and at least one of the type and the amount of the dopant added to the core of the single-core fiber 30a of the specific coupling waveguide 21a is made different from the type and the amount of the dopant added to the cores of the single-core fibers 30b to 30d of the other coupling waveguides 21b to 21d.

Although the present invention has been described by taking the above-described embodiments as an example, the present invention is not limited thereto. In the FIFO 20A, the optical characteristic of the coupling waveguide 21a only needs to be different from the optical characteristics of the other coupling waveguides 21b to 21d, and the optical characteristics of the coupling waveguide 21a may be different from the optical characteristics of the other coupling waveguides 21b to 21d according to another example. Such a modification will be described below. Note that the same or equivalent components as those in the first example are denoted by the same reference numerals, and redundant description is omitted unless otherwise specified.

First, the coupling waveguide 21a and the other coupling waveguides 21b to 21d may have different connection losses between the single-core fibers 30a to 30d and the waveguide member 40 as optical characteristics. Such a first modification will be described.

In the present modification, the lengths of the single core fibers 30a to 30d are the same, but a connection loss that is a loss of light at a connection portion C1a between the single-core fiber 30a and the waveguide member 40 in the coupling waveguide 21a is different from a connection loss that is a loss of light at connection portions C1b to C1d between the single-core fibers 30b to 30d and the waveguide member 40 in the other coupling waveguides 21b to 21d. As a method of changing such a connection loss, it is possible to change a mode field diameter between the single-core fibers 30a to 30d and the coupling waveguides 21a to 21d. According to the present modification, for example, the single-core fiber 30a in the FIFO 20A can be easily identified by the OTDR 70. Here, in particular, the shorter the single-core fiber, the larger the error in the measured propagation loss of the single-core fiber may be. However, according to the present modification, even if the single-core fibers 30a to 30d are short, the error can be suppressed to identify the single-core fiber 30a.

When the mode field diameter is changed in this manner, the difference between the connection loss at the connection portion C1a in the coupling waveguide 21a and the connection losses at the connection portions C1b to C1d in the other coupling waveguides 21b to 21d is preferably 0.01 dB or more, more preferably 0.1 dB or more, and still more preferably 0.5 dB or more. In addition, a difference in optical connection loss between the other coupling waveguides 21b to 21d is preferably less than 0.1 dB/km.

Note that the amount of eccentricity between the core 31 and the waveguide 61a at the connection portion C1a in the coupling waveguide 21a may be different from the amounts of eccentricity between the core 31 and the waveguides 61b to 61d at the connection portions C1b to C1d in the other coupling waveguides 21b to 21d. Even with such a configuration, the loss of light at the connection portion C1a in the coupling waveguide 21a is different from losses of light of the other coupling waveguides 21b to 21d at the connection portions C1b to C1d in the other coupling waveguides 21b to 21d, and for example, the single-core fiber 30a can be easily identified by the OTDR 70. In addition, with such a configuration, even if the single-core fibers 30a to 30d are short, the error can be suppressed and the single-core fiber 30a can be identified. In addition, when the waveguide member 40 includes the multicore fiber 50 and the pitch conversion unit 60 that optically couples the core 31 of each of the single-core fibers 30a to 30d and each of the cores 11a to 11d of the multicore fiber 50 as in the present modification, the connection state between the core 31 of each of the single-core fibers 30a to 30d and the pitch conversion unit 60 can be individually adjusted. However, when the position of the multicore fiber 50 with respect to the pitch conversion unit 60 is shifted, the positions of all the cores 11a to 11d of the multicore fiber 50 with respect to the pitch conversion unit 60 are shifted, and thus it is difficult to individually adjust the connection state between each of the cores 11a to 11d of the multicore fiber 50 and the pitch conversion unit 60. Thus, according to the present modification, the optical characteristic of the coupling waveguide 21a and the optical characteristics of the other coupling waveguides 21b to 21d can be easily made different from each other as compared with the case where the loss of light at the connection portion C2a between the multicore fiber 50 and the pitch conversion unit 60 in the coupling waveguide 21a is made different from the losses of light at the connection portions C2a to C2d between the multicore fiber 50 and the pitch conversion unit 60 in the other coupling waveguides 21b to 21d. The difference between the amount of eccentricity between the core 31 and the waveguide 61a at the connection portion C1a in the coupling waveguide 21a and the amounts of eccentricity between the core 31 and the waveguides 61b to 61d at the connection portions C1b to C1d in the other coupling waveguides 21b to 21d is preferably 10% or more, more preferably 20% or more, and still more preferably 30% or more of the diameter of the core 31.

From the viewpoint of making the connection loss different, the loss of light at the connection portion C2a between the multicore fiber 50 and the pitch conversion unit 60 in the coupling waveguide 21a may be different from the loss of light at the connection portions C2a to C2d between the multicore fiber 50 and the pitch conversion unit 60 in the other coupling waveguides 21b to 21d. In this case, for example, the connection loss at the connection portion C2a in the coupling waveguide 21a may be different from the connection losses at the connection portions C2b to C2d in the other coupling waveguides 21b to 21d. In addition, the amount of eccentricity between the core 11a and the waveguide 61a at the connection portion C2a in the coupling waveguide 21a may be different from the amounts of eccentricity between the cores 11b to 11d and the waveguides 61b to 61d at the connection portions C2b to C2d in the other coupling waveguides 21b to 21d.

The difference between the connection loss at the connection portion C2a in the coupling waveguide 21a and the connection loss at the connection portions C2b to C2d in the other coupling waveguides 21b to 21d is preferably 0.01 dB or more, more preferably 0.1 dB or more, and still more preferably 0.5 dB or more. In addition, the difference between the amount of eccentricity between the core 11a and the waveguide 61a at the connection portion C2a in the coupling waveguide 21a and the amount of eccentricity between the cores 11b to 11d and the waveguides 61b to 61d at the connection portions C2b to C2d in the other coupling waveguides 21b to 21d is, for example, preferably 10% or more, more preferably 20% or more, and still more preferably 30% or more of the diameters of the cores 11a to 11d.

Next, effective refractive indexes as the optical characteristics may be made different between the coupling waveguide 21a and the other coupling waveguides 21b to 21d. Such a second modification will be described.

In the present modification, the lengths of the single-core fibers 30a to 30d are the same, but the effective refractive index in the coupling waveguide 21a is different from the effective refractive indexes in the other coupling waveguides 21b to 21d. When the effective refractive index is changed without changing the length of the waveguide, for example, the optical path length measured by the OTDR 70 changes. Thus, even in the present modification, the single-core fiber 30a in the FIFO 20A can be easily identified by the OTDR 70. In addition, according to the present modification, even when the single-core fibers 30a to 30d are short, it is possible to identify the single-core fiber 30a while suppressing an error. The difference between the effective refractive index in the coupling waveguide 21a and the effective refractive indexes in the other coupling waveguides 21b to 21d is preferably 0.001 or more, more preferably 0.003 or more, and still more preferably 0.01 or more. The effective refractive index of the coupling waveguide 21a may be larger or smaller than the effective refractive indexes of the other coupling waveguides 21b to 21d, and the effective refractive indexes of the coupling waveguides 21a to 21d may be different from each other.

Next, bending losses as optical characteristics may be made different between the single-core fiber 30a and the other single-core fibers 30b to 30d. Such a third example will be described.

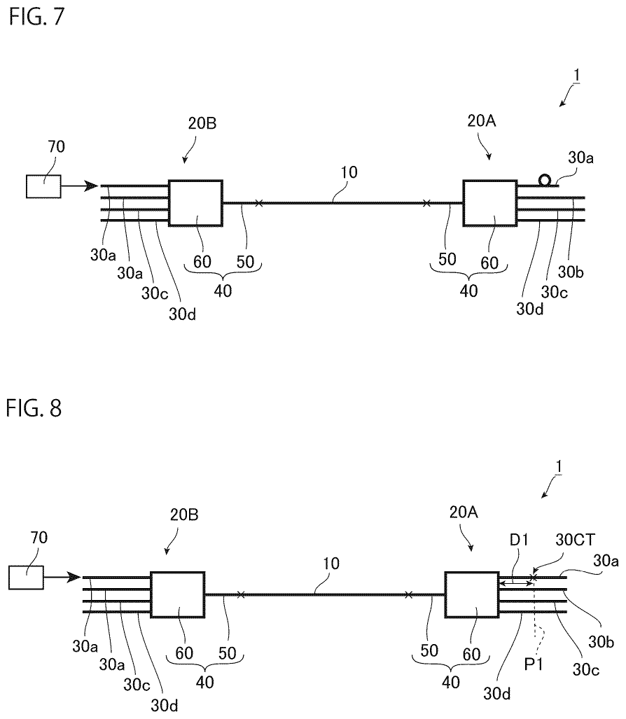

FIG. 7 is a conceptual diagram illustrating an optical communication apparatus according to a third modification. As illustrated in FIG. 7, in the present modification, the lengths of the single-core fibers 30a to 30d are the same, but the single-core fiber 30a is curved and the other single-core fibers 30b to 30d are non-curved. Thus, a bending loss of light occurs in the core 31 of the single-core fiber 30a, and a bending loss of light does not occur in the cores 31 of the other single-core fibers 30b to 30d. Therefore, even in the present modification, it is possible to easily make the optical characteristic of the coupling waveguide 21a different from the optical characteristics of the other coupling waveguides 21b to 21d. Note that, if the curvature of the single-core fiber 30a is different from the curvatures of the other single-core fibers 30b to 30d, the bending loss of light in the core 31 of the single-core fiber 30a and the bending loss of light in the core 31 of the other single-core fibers 30b to 30d can be made different, and the optical characteristic of the coupling waveguide 21a and the optical characteristics of the other coupling waveguides 21b to 21d can be made different. Thus, for example, the other single-core fibers 30b to 30d may also be curved. The difference between the bending loss of light at the core 31 of the single-core fiber 30a and the bending loss of light at the cores 31 of the other single-core fibers 30b to 30d is preferably 0.01 dB or more, more preferably 0.1 dB or more, and still more preferably 0.5 dB or more.

Next, the single-core fiber 30a may include a plurality of optical fiber portions. Such a fourth modification will be described.

FIG. 8 is a conceptual diagram illustrating an optical communication apparatus according to a fourth modification. As illustrated in FIG. 8, in the present modification, the lengths of the single-core fibers 30a to 30d are the same. However, the single-core fiber 30a is formed by connecting end portions of a plurality of optical fiber portions to each other, and the single-core fibers 30b to 30d are formed by one optical fiber unit. Thus, in the coupling waveguide 21a, a loss of light occurs at the connection portion 30CT between the optical fiber portions. Therefore, the loss of the light at the connection portion 30CT in the coupling waveguide 21a is different from the loss of the light of the coupling waveguides 21b to 21d at the position P1 corresponding to the connection portion 30CT of the coupling waveguide 21a in the other coupling waveguides 21b to 21d. Specifically, the position P1 is equivalent to a position separated along the longitudinal direction from tips of the other single-core fibers 30b to 30d on the waveguide member 40 side by a distance D1 from a tip of the single-core fiber 30a to the connection portion 30CT on the waveguide member 40 side along the longitudinal direction of the single-core fiber 30a, and is indicated by a broken line in FIG. 8. Even in the present modification, for example, the single-core fiber 30a can be easily identified by the OTDR 70. In addition, according to the present modification, even when the single-core fibers 30a to 30d are short, it is possible to identify the single-core fiber 30a while suppressing an error.

Note that the loss of light at the connection portion 30CT in the coupling waveguide 21a only needs to be different from the loss of light at the above-described position P1 in the coupling waveguides 21b to 21d. To this extent, for example, the other single-core fibers 30b to 30d may also have a configuration in which a plurality of optical fiber portions is connected to each other in the longitudinal direction. In addition, as long as the loss of light at the connection portion 30CT in the coupling waveguide 21a is different from the loss of light at the above-described position P1 in the coupling waveguides 21b to 21d, the connection portion 30CT between the optical fiber portions may be provided at the above-described position P1 in the single-core fibers 30b to 30d. In this case, for example, the inclination of the joining surface of the optical fiber portion at the connection portions 30CT of the single-core fibers 30b to 30d is made different from the inclination of the joining surface of the optical fiber portion at the connection portions 30CT of the optical fiber portions of the single-core fiber 30a. The inclination of the joining surface of the optical fiber portion is an inclination with respect to a direction perpendicular to the extending direction of the optical fiber portion. With such a configuration, it is possible to make the loss of light at the connection portion 30CT in the coupling waveguide 21a different from the loss of light at the above-described position P1 in the coupling waveguides 21b to 21d. The difference between the loss of light at the connection portion 30CT in the coupling waveguide 21a and the loss of light at the above-described position P1 in the coupling waveguides 21b to 21d is preferably 0.01 dB or more, more preferably 0.1 dB or more, and still more preferably 0.5 dB or more.

The number of the connection portions 30CT is not limited, and the number of the connection portions 30CT of the single-core fiber 30a may be different from the number of the connection portions 30CT of the other single-core fibers 30b to 30d. In this case, even if the loss of light at the connection portion 30CT in the coupling waveguide 21a is the same as the loss of light at the above-described position P1 in the coupling waveguides 21b to 21d, the single-core fiber 30a in the FIFO 20A can be identified by measuring the number of connection portions 30CT by, for example, the OTDR 70 or the like. In addition, in this case, the single-core fiber 30a is identified on the basis of a discrete natural number such as the number of connection portions 30CT, but a loss such as a propagation loss generally does not become a natural number. Thus, the single-core fiber 30a can be easily identified as compared with the case of identifying the single-core fiber on the basis of a difference in loss such as a propagation loss. In addition, with such a configuration, even if the single-core fibers 30a to 30d are short, the error can be suppressed and the single-core fiber 30a can be identified.

In addition, when the number of the connection portions 30CT of the single-core fiber 30a is the same as the number of the connection portions 30CT of the other single-core fibers 30b to 30d, at least one connection portion 30CT of the other single-core fibers 30b to 30d may be located at a position other than the above-described position P1.

Next, an inclination of an end surface of the single-core fiber 30a on the other end side opposite to the waveguide member 40 may be made different from inclinations of end surfaces on the other end sides of the other single-core fibers 30b to 30d. The inclination of the end surface is an inclination with respect to a direction perpendicular to the extending direction of each of the single-core fibers 30a to 30d. Such a fifth modification will be described.

In the present modification, as described above, the lengths of the single-core fibers 30a to 30d are the same, but the inclination of an end surface on the other end side of the single-core fiber 30a is different from an inclination of the end surfaces on the other end sides of the other single-core fibers 30b to 30d. Thus, energy of light reflected by the end surface on the other end side of the single-core fiber 30a is different from energy of light reflected by the end surfaces on the other end sides of the other single-core fibers 30b to 30d. Thus, even in the present modification, for example, the single-core fiber 30a can be easily identified by the OTDR 70. The difference between the energy of the light reflected by the end surface on the other end side of the single-core fiber 30a and the energy of the light reflected by the end surfaces on the other end sides of the other single-core fibers 30b to 30d is preferably 3 dB or more, more preferably 10 dB or more, and still more preferably 20 dB or more. Note that the single-core fiber 30a and the other single-core fibers 30b to 30d only need to have different energy of light reflected by the end surface on the side opposite to the waveguide member 40 side, and for example, the single-core fiber 30a and the other single-core fibers 30b to 30d may have different surface roughness of the end surfaces.

Next, an optical element that reflects light of a specific wavelength may be provided in the single-core fiber 30a. Such a sixth modification will be described.

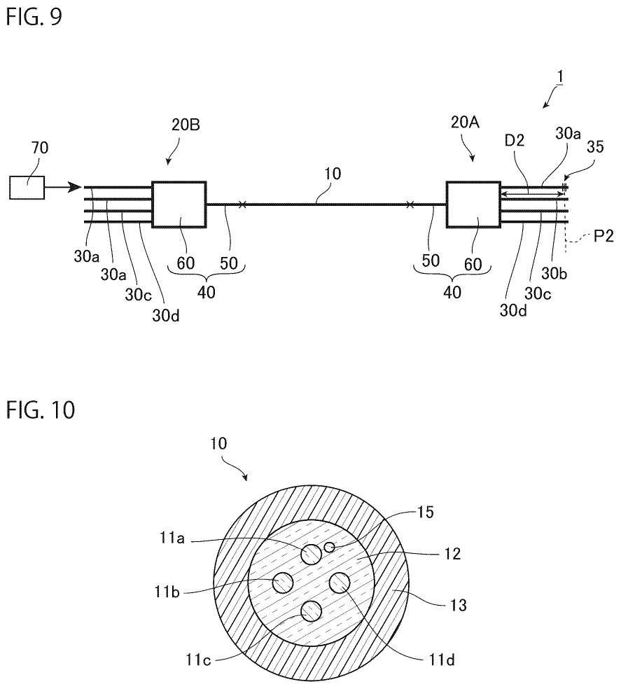

FIG. 9 is a conceptual diagram illustrating an optical communication apparatus according to a sixth modification. As illustrated in FIG. 9, in the present modification, the lengths of the single-core fibers 30a to 30d are the same. However, the single-core fiber 30a is provided with an FBG 35 as an optical element that reflects light of a specific wavelength, and the FBG 35 is not formed in the single-core fibers 30b to 30d. Thus, reflectance of light of a specific wavelength at the position where the FBG 35 of the single-core fiber 30a is provided in the coupling waveguide 21a is different from reflectance of the light of the specific wavelength at a position P2 corresponding to the position where the FBG 35 of the coupling waveguide 21a is provided in the other coupling waveguides 21b to 21d. Specifically, the position P2 is equivalent to a position separated along the longitudinal direction from the tips of the other single-core fibers 30b to 30d on the waveguide member 40 side by a distance D2 from the tip of the single-core fiber 30a to the FBG 35 on the waveguide member 40 side along the longitudinal direction of the single-core fiber 30a, and is indicated by a broken line in FIG. 9. According to the present modification, the single-core fiber 30a can be identified by converting the measurement light into light including the light of the specific wavelength described above. In addition, even if the single-core fibers 30a to 30d are short, it is possible to identify the single-core fiber 30a while suppressing an error. Note that the specific wavelength is preferably a wavelength other than the communication wavelength band, and with such a configuration, it is possible to identify the single-core fiber 30a while suppressing the influence on the transmission quality. The difference between the amount of the light of the specific wavelength reflected at the position where the FBG 35 of the single-core fiber 30a is provided in the coupling waveguide 21a and the amount of the light of the specific wavelength reflected at the above-described position P2 in the other coupling waveguides 21b to 21d is preferably 0.1 dB or more, more preferably 1 dB or more, and still more preferably 5 dB or more.

Note that the reflectance of the light of the specific wavelength at the position where the FBG 35 of the single-core fiber 30a is provided in the coupling waveguide 21a only needs to be different from the reflectance of the light of the specific wavelength at the above-described position P2 in the other coupling waveguides 21b to 21d. For example, an FBG that reflects light of a specific wavelength different from the t wavelength of light reflected by the FBG 35 provided in the single-core fiber 30a may be provided in the other single-core fibers 30b to 30d. In addition, specific wavelengths of light reflected by the FBGs provided in the single-core fibers 30a to 30d may be different from each other or may be the same. When the wavelengths are different from each other, the difference in reflected wavelength is preferably 1 nm or more, more preferably 30 nm or more, and still more preferably 200 nm or more.

The number of FBGs 35 is not limited, and the number of FBGs 35 provided in the single-core fiber 30a may be different from the number of FBGs provided in the other single-core fibers 30b to 30d. In this case, even if specific wavelengths of light reflected by the FBGs provided in the single-core fibers 30a to 30d are the same, for example, the single-core fiber 30a in the FIFO 20A can be easily identified by the OTDR 70.

When the number of FBGs 35 provided in the single-core fiber 30a is the same as the number of FBGs provided in the other single-core fibers 30b to 30d, at least one FBG provided in the other single-core fibers 30b to 30d may be provided at a position other than the above-described position P2. In this case, even if specific wavelengths of light reflected by the FBGs provided in the single-core fibers 30a to 30d are the same, for example, the single-core fiber 30a in the FIFO 20A can be easily identified by the OTDR 70.

The optical element that reflects light of a specific wavelength is not limited to the FGB, which is a fiber type optical element, and may be, for example, a lens, a mirror, a filter, or the like, which is a bulk type optical element. In a case where the optical element that reflects light of a specific wavelength is a bulk-type optical element, the light emitting element is provided, the single-core fiber is formed by connecting end portions of a plurality of optical fiber portions to each other, and the optical element is provided between adjacent optical fiber portions.

Next, a marker may be provided on the multicore fiber 50. Such a seventh modification will be described.

FIG. 10 is a view illustrating a cross section perpendicular to the longitudinal direction of the multicore fiber 50 according to the seventh modification. In the present modification, as illustrated in FIG. 10, the multicore fiber 50 includes a marker 15. A distance between a core 11a, which is a part of the coupling waveguide 21a, and the marker 15 is smaller than a distance between cores 11b to 11d, which are parts of other coupling waveguides 21b to 21d, and the marker 15. Thus, according to the present modification, light leaking from the core 11a of the multicore fiber 50, which is a part of the coupling waveguide 21a, is easily affected by the marker 15. Examples of the influence of the marker 15 on the light leaking from the core 11a include the influence of impurities added to the marker 15, the influence of unevenness of the interface between the marker 15 and the cladding 12, and the like. Examples of the impurities added to the marker 15 include dopants that increase the loss of moisture and the above-described light, and dopants such as germanium, iron, and boron. As a method of increasing the unevenness of the interface, for example, when a base material of the multicore fiber 50 is manufactured by a drilling method, the surface roughness of an outer peripheral surface of a marker rod to be the marker 15 and the surface roughness of a surface defining a hole into which the marker rod is inserted in a cladding rod to be the cladding 12 can be roughened. As the light leaking from the core 11a spreads to the marker 15, the loss of light increases due to the above influence. Thus, the loss of light propagating through the core 11a can be made larger than the loss of light propagating through the other cores 11b to 11d. Therefore, according to the present modification, for example, even if the materials constituting the cores 11b to 11d of the multicore fiber 50 are the same, the optical characteristic of the coupling waveguide 21a can be made different from the optical characteristics of the other coupling waveguides 21b to 21d. In addition, the core 11a of the multicore fiber 50, which is a part of the coupling waveguide 21a, can be visually identified based on the marker 15.

In the above embodiments, the FIFO 20B in which the optical characteristics of the coupling waveguides 21a to 21d are substantially the same has been described as an example. However, similarly to the FIFO 20A, in the FIFO 20B, the optical characteristic of the coupling waveguides 21a may be different from the optical characteristics of the other coupling waveguides 21b to 21d, and the optical characteristics of the coupling waveguides 21a to 21d may be different from or the same as each other.

In the above embodiments, the waveguide member 40 including the multicore fiber 50 and the pitch conversion unit 60 has been described as an example. However, the waveguide member 40 has a plurality of waveguides optically coupled to the respective cores 31 of the single-core fibers 30a to 30d, and a distance between these waveguides on the single-core fibers 30a to 30d side only needs to be equal to or more than a distance between these waveguides on the side opposite to the single-core fibers 30a to 30d. For example, the waveguide member 40 may include only the pitch conversion unit 60. Further, the pitch conversion unit 60 has a plurality of waveguides extending from one end to the other end and can be connected to the optical communication member, and a distance between the plurality of waveguides at the other end on the single-core fibers 30a to 30d side only needs to be larger than a distance between the plurality of waveguides at one end. For example, the pitch conversion unit 60 may be a spatial optical system including a plurality of lenses. In addition, the pitch conversion unit 60 may be formed integrally with the plurality of single-core fibers 30a to 30d, and the connection portions C1a to C1d between the single-core fibers 30a to 30d and the waveguide member 40 may not be formed. Such a waveguide member 40 can be formed, for example, by extending an end portion of a fiber bundle in which a plurality of single-core fibers 30a to 30d is bundled. The above-described waveguide member 40 can also be formed by bundling one end portions of the plurality of single-core fibers 30a to 30d or bundling one end portions of the plurality of single-core fibers 30a to 30d in which the outer diameter of the cladding is reduced at one end portion. In these cases, the cores 31 of the single-core fibers 30a to 30d and the respective waveguides of the waveguide member 40 are optically coupled without passing through the boundary surface, and the waveguides coupled in this manner become at least a part of the coupling waveguides 21a to 21d. In these cases, at one end portions of the single-core fibers 30a to 30d which are the waveguide members 40, distances between the plurality of waveguides may be the same at one end and the other end. In this case, the pitch conversion unit 60 is unnecessary.

In addition, a plurality of types of optical characteristics may be different between the specific coupling waveguide 21a and the other coupling waveguides 21b to 21d. For example, the single-core fiber 30a and the single-core fibers 30b to 30d may have different propagation losses and lengths. With such a configuration, it is possible to more easily identify the single-core fiber 30a in the FIFO 20A. Each of the single-core fibers 30a to 30d may have optical characteristics different from those of other single-core fibers. For example, the single-core fiber 30a and the single-core fibers 30b to 30d may have different propagation losses, the single-core fiber 30b and the single-core fibers 30a, 30c, and 30d may have different lengths, the single-core fiber 30c and the single-core fibers 30a, 30b, and 30d may have different light losses at the connection portions C1a to C1d with the waveguide member 40, and the single-core fiber 30d and the single-core fibers 30a to 30c may have different inclinations of end surfaces opposite to the waveguide member 40. With such a configuration, the plurality of single-core fibers 30a to 30d can be easily identified.

Note that a plurality of the above-described embodiments and the above-described modifications may be combined. Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

As described above, according to one or more embodiments, a fan-in/fan-out device and an optical communication apparatus capable of identifying a specific single-core fiber when connected to an optical communication member are provided, and are expected to be used in the field of optical fiber communication and the like.

1. A fan-in/fan-out device comprising:
single-core fibers; and
a waveguide member including waveguides that:
are each optically coupled to a core of a corresponding one of the single-core fibers, and
connect to an optical communication member, wherein
a distance between adjacent waveguides of the waveguides on a side of the single-core fibers is equal to or greater than a distance between adjacent waveguides of the waveguides on a side opposite to the single-core fibers, and
an optical characteristic of a first coupling waveguide including the core of a first single-core fiber of the single-core fibers and the waveguide coupled to the core of the first single-core fiber is different from an optical characteristic of a second coupling waveguide including the core of a second single-core fiber of the single-core fibers and the waveguide coupled to the core of the second single-core fiber.

2. The fan-in/fan-out device according to claim 1, wherein a propagation loss of light of the first coupling waveguide is different from a propagation loss of light of the second coupling waveguide.

3. The fan-in/fan-out device according to claim 1, wherein a propagation loss of light of a wavelength other than a communication wavelength band in the first coupling waveguide is different from a propagation loss of the light of the wavelength in the second coupling waveguide.

4. The fan-in/fan-out device according to claim 1, wherein a curvature of the first single-core fiber is different from a curvature of the second the single-core fiber.

5. The fan-in/fan-out device according to claim 1, wherein a loss of light at a first connection portion in which the first single-core fiber and the waveguide member are connected in the first coupling waveguide is different from a loss of light at a second connection portion in which the second single-core fiber and the waveguide member are connected in the second coupling waveguide.

6. The fan-in/fan-out device according to claim 5, wherein an amount of eccentricity between the core of the first single-core fiber and the waveguide coupled to the first single-core fiber at the first connection portion is different from an amount of eccentricity between the core of the second single-core fiber and the waveguide coupled to the second single-core fiber at the second connection portion.

7. The fan-in/fan-out device according to claim 1, wherein an effective refractive index in the first coupling waveguide is different from an effective refractive index in the second coupling waveguide.

8. The fan-in/fan-out device according to claim 1, wherein
the first single-core fiber is constructed by connecting end portions of optical fiber portions to each other, and
a loss of light at a connection portion between the optical fiber portions in the first coupling waveguide is different from a loss of light at a position in the second coupling waveguide corresponding to the connection portion of the first coupling waveguide.

9. The fan-in/fan-out device according to claim 1, wherein
the first single-core fiber and the second single-core fiber are constructed by connecting end portions of optical fiber portions to each other, and
a total number of connection portions between the optical fiber portions in the first single-core fiber is different from a total number of connection portions between the optical fiber portions in the second single-core fiber.

10. The fan-in/fan-out device according to claim 1, wherein
the first single-core fiber includes an optical element that reflects light of a specific wavelength, and
a reflectance of the light of the specific wavelength at a position of the optical element in the first coupling waveguide is different from a reflectance of the light of the specific wavelength at a position in the second coupling waveguide corresponding to the position of the optical element in the first coupling waveguide.

11. The fan-in/fan-out device according to claim , wherein a length of the first single-core fiber is different from a length of the second single-core fiber.

12. The fan-in/fan-out device according to claim 1, wherein
the waveguide member further includes:
a multicore fiber; and
a pitch conversion unit that optically couples the core of each of the single-core fibers and each of cores of the multicore fiber, and
the multicore fiber has a marker in which a distance from one of the cores of the multicore fiber that is a part of the first coupling waveguide is smaller than a distance from another of the cores of the multicore fiber that is a part of the second coupling waveguide.

13. An optical communication apparatus comprising:
a pair of fan-in/fan-out devices, wherein at least one of the pair of fan-in/fan-out devices is the fan-in/fan-out device according to claim 1; and
a transmission multicore fiber optically coupling each of the waveguides of the waveguide member of one of the pair of fan-in/fan-out devices and each of the waveguides of the waveguide member of the other of the pair of fan-in/fan-out devices.
